(19) United States
(12) Patent Application Publication
(10) Pub. No.: US 2015/0197027 A1
(43) Pub. Date: Jul. 16, 2015

(54) REMOVABLE STOP FOR A BOARD-CUTTING TOOL, AND CUTTING TOOL COMPRISING SUCH A REMOVABLE STOP

(71) Applicant: ETABLISSEMENTS PIERRE GREHAL ET CIE SA, Baillet-en-France (FR)

(72) Inventor: Lionel MARCON, Parmain (FR)

(21) Appl. No.: 14/594,351

(22) Filed: Jan. 12, 2015

(30) Foreign Application Priority Data
Jan. 13, 2014 (FR) 1450247

(51) Int. Cl. B26D 7/01

(52) U.S. Cl. CPC B26D 7/01

(57) ABSTRACT

An economic and well-performing stop for a board-cutting tool comprising:
a support,
a blade mounted on the support via a pivot so that it can pivot between an open position for receiving, between the support and the blade, the board that is to be cut, and a closed position at the end of cutting,
a slot intended to receive at least part of the blade during the cutting, the slot being borne by a portion of the support and comprising a proximal end close to the pivot and a distal end, distant from the pivot, comprising a shoulder; The stop (200) is characterized in that it comprises, with respect to the position of use:
a contact face (201) for contact with the board that is to be cut; and
a central claw (202) intended to be forcibly inserted under the shoulder (4) of the slot.

The invention relates to a removable stop for a board-cutting tool and to a cutting tool comprising such a removable stop.

In the field of modern construction, use is often made of building elements formed or reconstituted from materials which take or are reduced to the form of powder, fibres, granules or chips. Thus, by way of nonlimiting example, use is made of tiles or boards of plasterboard, cement or ceramic as building or finishing elements, cladding sheets made of asbestos cement, sheets of medium-density cellulose-fibreboard as cladding or finish panels and laminated boards as floating floor elements. Because of the nature of the mixture of components from which the boards are made or because of the use to which the boards are put, the boards have two characteristics in common: the hardness of the board, or at least of the working face thereof, and the thickness thereof.

When the boards are made of a reconstituted material that combines hardness with thickness, it is necessary to have use of a tool capable of overcoming these two cutting difficulties.

There are a great many tools in existence capable of cutting such boards. Nevertheless, because these boards are fitted on site, the tool needs to be suited to site use, i.e. to being used outside of a workshop.

Such a tool is described for example in documents WO2006095065 and EP2083972. It is a cutting tool for cutting a board made of a reconstituted material, the tool comprising a support on which a blade is mounted via a pivot so that it can pivot between an open position for receiving, between the support and the blade, the board that is to be cut, and a closed position at the end of cutting. The blade has a flat and curved cutting edge and is provided with a handle. As the hardness of the boards that are to be cut is generally high, a lever arm is generally provided, between the handle and the blade, so that a greater force can be applied.

The support comprises a slot intended to receive at least part of the blade during cutting.

By collaborating with the edges of the slot, the blade performs a double scissors action: the flat and clean cutting edge of the blade slides along the longitudinal edges of the slot, like two pairs of scissors. This double scissors action means that the blade does not, during cutting, penetrate the board that is to be cut in the usual way in order to slit it but removes a strip of material from the board, the width of the strip more or less corresponding to that of the blade.

In order to ensure that the cuts in the boards are even, the tool described in the abovementioned documents comprises a support that has a large area of contact with the board that is to be cut. Because this surface area includes the slot that receives the blade, it is necessary to provide a relatively wide support. This support therefore generally consists of a metal sheet having an inverted U-shape (bent or welded) so that it has two flanges and a web. The slot is cut into the web of the inverted U-shape. The width of the web has to be large enough for the sheet not to tip during cutting.

That generally entails the use of a larger amount of raw material, thereby increasing the weight of the tool and, of course, the price thereof.

This price is thus increased by the use of cutting accessories, such as a support consisting of a trestle to be placed under the sheet prior to cutting, and/or as a stop that is angularly adjustable so as to allow transverse cuts to be made across the boards at chosen angles.

Thus, documents WO2006095065 and EP2083972 propose providing, on the support, a fixed stop at the opposite end of the slot from the pivot axis of the blade. This stop comprises a straight edge intended to be in contact with the board that is to be cut. The stop is either equipped with means of collaborating with angular-cutting accessories or mounted such that it can pivot. The stop can slide in the slot in order to reduce the distance between the stop and the pivot of the blade. Once the distance has been adjusted, the stop is screwed in position.

Although these tools allow the cutting angle to be adjusted, the stop is sophisticated and provided with numerous options that are costly in terms of weight and in terms of raw material.

It is an objective of the present invention to propose a tool for cutting boards made of reconstituted material that is economical, performs well, is easily transported, limits the cutting dust that may impair quality fitting and is multifunctional.

What is meant by “performs well” is that the cut needs to be accurate, at least on one of the faces (the cut through the thickness of the board may be less precise when this thickness is not visible in the final fit). Thus, the cut needs to be clean on at least one of the faces, and the cutting angle needs to be constant.

What is meant by “multifunctional” is that the tool must be capable of cutting rectangular boards both in the transverse direction (across the width of the board) and also in the longitudinal direction (along the length of the board).

In the remainder of the present description, a cut in the transverse direction will be referred to as a cut (this cut may be parallel to the width of the board or at an angle to the width of the board). A cut in the longitudinal direction will be referred to as a trimming cut.

To this end, one subject of the invention is a stop for a tool for cutting a board made of a reconstituted material, the tool comprising:
a support,
a blade mounted on the support via a pivot so that it can pivot between an open position for receiving, between the support and the blade, the board that is to be cut, and a closed position at the end of cutting,
a slot intended to receive at least part of the blade during the cutting, the slot being borne by a portion of the support and comprising a proximal end close to the pivot and a distal end, distant from the pivot, comprising a shoulder;
the stop comprising, with respect to the position of use:
a contact face for contact with the board that is to be cut; and
a central claw intended to be forcibly inserted under the shoulder of the slot.

According to other embodiments:
the stop further comprises two blocks referred to as “lateral blocks”, which are arranged one on either side of the central claw at a distance from one another that is just less than a width of the portion of the support bearing the slot so that they are forcibly inserted one on either side of said portion;
the stop further comprises at least one retaining lip for retaining said board, this lip running perpendicular to the contact face;
the stop further comprises at least one support lip for supporting said board, this lip running perpendicular to the contact face so as to lie flush with the slot in a position of use;
the retaining lip and/or the supporting lip may be mounted removably on the stop;
the retaining lip and the supporting lip may be spaced apart by a distance just less than, equal to or greater than the thickness of the board that is to be cut; and/ or
the stop further comprises a fixing means for fixing at least one removable block so that it presses against the contact face of the stop.

Another subject of the invention is a cutting tool for cutting a board made of a reconstituted material, the tool comprising a support on which a blade is mounted via a pivot so that it can pivot between an open position for receiving, between the support and the blade, the board that is to be cut, and a closed position at the end of cutting, the support comprising a portion equipped with a slot intended to receive at least part of the blade during cutting, the slot comprising a proximal end close to the pivot and a distal end distant from the pivot, in which:
the slot comprises a shoulder at its distal end;
a stop according to the invention is mounted removably in the slot, a central claw of the stop being forcibly inserted under the shoulder of the slot.

According to another embodiment, the tool further comprises at least one removable block intended to be fixed so that it bears against the contact face of the stop.

Other features of the invention will be listed in the detailed description that follows, given with reference to the attached drawings which respectively depict:

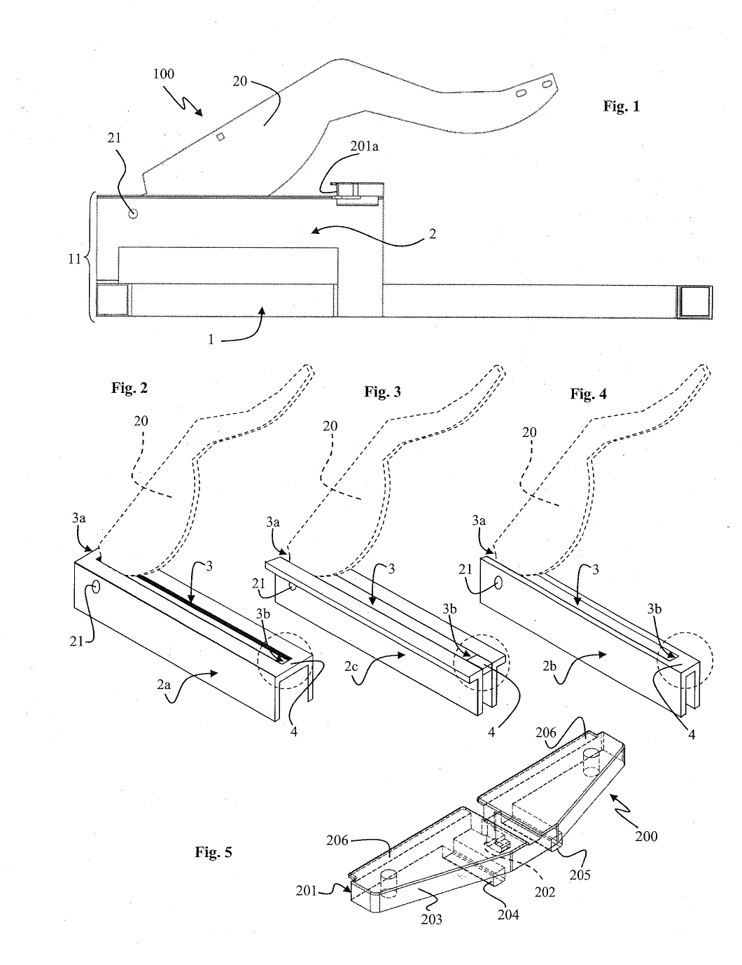

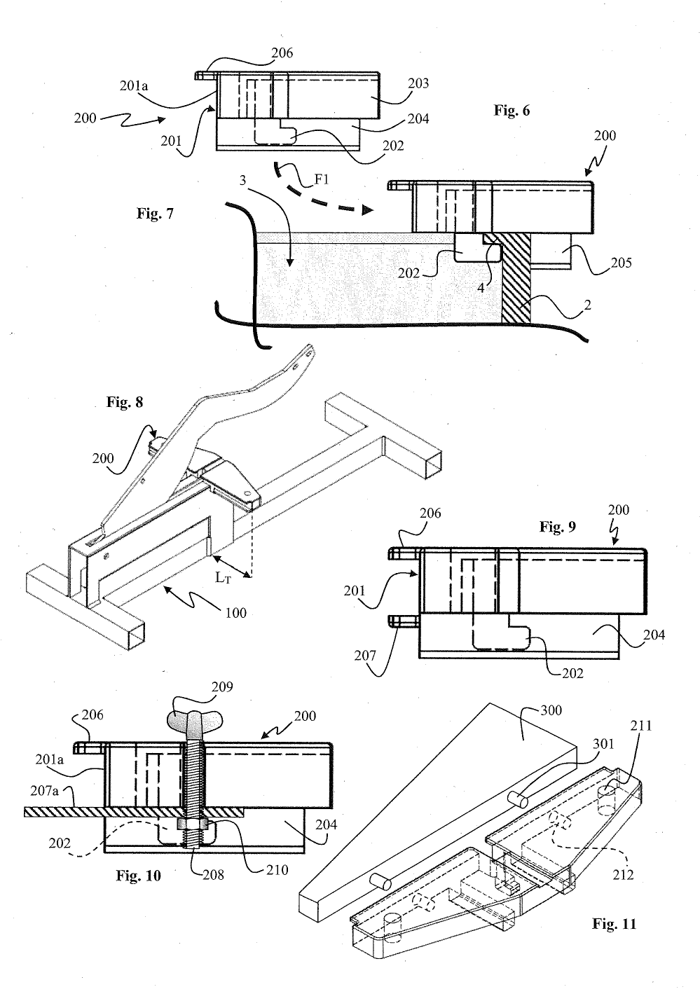

FIG. 1: a schematic side view of a cutting tool for cutting boards made of reconstituted material and equipped with a stop according to the invention;

FIGS. 2 to 4: schematic perspective views of three embodiments of the portion of the support of a tool according to the invention that is equipped with the slot;

FIG. 5: a schematic perspective view of one embodiment of a stop according to the invention;

FIG. 6: a schematic side view of the stop of FIG. 5;

FIG. 7: a schematic side view of the stop of FIG. 5 in the position of use;

FIG. 8: a schematic perspective view of a cutting tool equipped with a stop according to the invention;

FIG. 9: a schematic side view of a stop according to the invention, provided with a removable support lip;

FIG. 10: a schematic side view of a stop according to the invention equipped with a fixed support lip; and

FIG. 11: a schematic perspective view of the embodiment of FIG. 5 during the process of fixing to a removable block.

FIG. 1 illustrates a cutting tool 100 for cutting a board made of reconstituted material, the tool comprising a support 10 and a blade 20 pivot mounted on the support by a pivot 21.

The support 10 comprises a subframe portion 11 and a support portion 12 supporting the blade 2, this support portion 12 comprising a slot 3 intended to receive at least part of the blade 2 during cutting.

The slot 3 is visible in FIGS. 2 to 4 which illustrate three embodiments 2a, 2b, 2c of the support portion equipped with the slot 3.

In the embodiment of FIG. 2, the support portion comprising the slot 3 consists of a metal sheet bent into an inverted U-shape with the slot cut in the web thereof in such a way as to form a shoulder.

In the embodiment of FIG. 3, the portion of the support that comprises the slot 3 consists of two metal sheets bent into inverted L-shapes which are parallel to one another and to which a third metal sheet constituting the shoulder 4 has been welded.

In the embodiments of FIGS. 2 and 3, the slot is bordered by a broad rim (greater than the thickness of the sheets used) to provide the to board that is to be cut with support during cutting.

In the embodiment of FIG. 4, that portion of the support that comprises the slot 3 consists of two mutually parallel flat metal sheets to which has been welded a third sheet constituting the shoulder 4. Alternatively, it could be a metal sheet that has been precut to make a cutout, then bent into an inverted U-shape so that the cutout constitutes the slot 3 and the part that has not been cut away forms the shoulder 4.

In this embodiment, the slot is bordered by a narrow rim consisting of the edge face (the thickness) of each sheet. While this embodiment is very economical, it is necessary to provide a means of supporting the board that is to be cut.

According to the invention, the slot comprises a proximal end 3a close to the pivot 21 and a distal end 3b distant from the pivot 21, this distal end 3b comprising a shoulder 4 (surrounded in FIGS. 2 to 4 by a circle drawn in dotted line).

This shoulder 4 is intended to allow a stop according to the invention, illustrated in FIG. 5, to be fitted.

The stop 200 according to the invention comprises:
a contact face 201 for contact with the board that is to be cut (for the sake of the clarity of the figures, this board has not been illustrated); and
a central claw 202 intended to be forcibly inserted under the shoulder 4 of the slot 3.

In general, the contact face and the claw are borne by a plate 203 the shape of which is arbitrary provided that the contact surface 201a (see FIG. 1) for contact with the board that is to be cut is flat.

Advantageously, as illustrated in FIG. 5, the stop according to the invention further comprises two lateral blocks 204 and 205 arranged one on either side of the central claw 202 at a distance apart that is just less than the width of that portion of the support 10 that bears the slot.

Thus, the stop can be forcibly inserted under the shoulder 4 and either side of said portion when the stop is being fitted.

Furthermore, these lateral blocks provide better transverse retention of the stop which cannot pivot accidentally during cutting.

The contact face 201 bearing the flat contact surface 201a advantageously comprises at least one retaining lip and/or support lip arranged above and/or below the contact surface 201a in the position of use.

In FIG. 5, the stop comprises two retaining lips 206 running perpendicular to the contact face 201. These lips prevent the board from bending upwards into a V shape when the blade cuts transversely through the board.

These retaining lips are positioned above the contact surface 201a in such a way that the board can slide in underneath. The layout of the retaining lip may be chosen so that, in the position of use, a space just smaller than, equal to or greater than the thickness of the board that is to be cut is formed between the support and the retaining lip. If the space is just less than the thickness, the board has to be forcibly inserted under the retaining lip, and this prevents the user having to hold the board during cutting.

The fitting of the stop 200 according to the invention on the tool of FIG. 1 is illustrated in FIGS. 6 and 7.

In FIG. 6, the stop 200 is illustrated in side view. The claw 202 is illustrated in dotted line because it is situated behind the lateral block 204 in this side view.

The stop 200 is inserted on the support portion 12 in the direction of the arrow F1. The claw 202 is inserted into the slot 3 so that the lateral blocks (when present) are positioned one on each side of the support portion 12. The claw is then forcibly inserted under the shoulder 4.

FIG. 7 illustrates this final position of use, viewed in cross section, and FIG. 8 illustrates this final position of use in side view.

FIG. 9 illustrates one advantageous embodiment of the stop according to the invention, which also performs a function of supporting the plate. Thus, the stop 200 according to the invention preferably comprises at least one support lip 207 running perpendicular to the contact face 201 so as to lie flush with the level of the slot in the position of use (see FIG. 8).

The support lip 207 supports the board while it is being cut, this, when this board is long, preventing it from breaking or tearing during cutting.

This is particularly advantageous because it is possible to produce a support that is very economical, according to FIG. 4, but at the same time supports the board that is to be cut during cutting.

Thus, by virtue of the support lip 207, it is possible to get around the use of a separate trestle for supporting the board during cutting.

When the stop according to the invention comprises a retaining lip 206 and/or a support lip, it needs to be sized so that it protrudes transversely beyond the support over a transverse length L_{T} that is long enough to provide the retention and/or support. For preference, the length L_{T} is at least equal to 2 cm, preferably at least 5 cm, advantageously at least 10 cm.

Advantageously, the stop according to the invention is produced by moulding a plastic material. Moulding can be done as a single piece or as several pieces fixed together. For example, the retaining and support lips may be added on or may be moulded in directly.

In the embodiment of FIG. 10, the stop according to the invention comprises a moulded-in retaining lip 206 whereas the support lip 207a is attached to the stop. It is fixed in position by a bolt 208 clamped by two nuts 209-210 via a hole 211.

The support lip 207a may be made up of a plate of relatively small transverse width (1 to 3 cm) if the hole 211 is situated towards the periphery of the stop.

The plate may be screwed so that it is perpendicular to the contact fact 201. However, the angle formed by the plate may advantageously be open, i.e. the free end of the plate 207a is further away from the support portion 12 than the end fixed to the stop 200.

In this case, the plate 207a may advantageously have a relatively long length (in excess of 5 cm) because by opening up the angle the position at which the board that is to be cut is supported is moved away from the support.

The retaining lip and the support lip are spaced apart by a distance just less than, equal to or greater than the thickness of the board that is to be cut.

The stop according to the invention is not orientable once it has been positioned in the slot. Indeed the use of lateral blocks rather ensures that the stop is held firmly in the position of use.

However, it is possible to provide a means of fixing at least one removable block so that it presses against the contact face of the stop.

FIG. 11 illustrates one embodiment in which a block 300 is in the process of being fixed to the stop 200 by dowels 301 intended to be forcibly inserted into blind holes 212 borne by the contact face 201. Any other fixing means may be used, such as, for example, magnets embedded within the mass of the stop 200 and of the block 300.

If the contact face 201 is perpendicular to the slot when the stop 200 is in the position of use, the block 300 may have a contact face at a different angle.

When the user does not need to make a crosscut, but rather needs to trim a board, all that he needs to do is remove the stop forcibly from the slot in the opposite direction to the arrow F1.

Advantageously, the support 10 comprises a stop support into which the claw of this stop can be forcibly inserted in order to prevent the stop from falling.

It is thus possible to store the stop on the tool when the stop is not in use.

The invention therefore proposes a stop that is very economical, and can be manufactured in rigid plastic material, is lightweight, multifunctional, provides a quality cut, and is practical.

1. Stop (200) for a tool (100) for cutting a board made of a reconstituted material, the tool comprising:
a support (101-2),
a blade (20) mounted on the support via a pivot (4) so that it can pivot between an open position for receiving, between the support (101-2) and the blade (20), the board that is to be cut, and a closed position at the end of cutting,
a slot (3) intended to receive at least part of the blade during the cutting, the slot being borne by a portion of the support (2) and comprising aproximal end (3a) close to the pivot (4) and a distal end (3b), distant from the pivot, comprising a shoulder (4);
characterized in that the stop (200) comprises, with respect to the position of use:
a contact face (201) for contact with the board that is to be cut; and
a central claw (202) intended to be forcibly inserted under the shoulder (4) of the slot.

2. Stop according to claim 1, further comprising two blocks (204-205) referred to as “lateral blocks”, which are arranged one on either side of the central claw (202) at a distance from one another that is just less than a width of the portion of the support bearing the slot so that they are forcibly inserted one on either side of said portion.

3. Stop according to claim 1, further comprising at least one retaining lip (206) for retaining said board, this lip running perpendicular to the contact face.

4. Stop according to claim 1, further comprising at least one support lip (207-207a) for supporting said board, this lip running perpendicular to the contact face so as to lie flush with the slot in a position of use.

5. Stop according to claim 3, in which the retaining lip and/or the supporting lip is/are mounted removably on the stop.

6. Stop according to claim 3, in which the retaining lip and the supporting lip are spaced apart by a distance just less than, equal to or greater than the thickness of the board that is to be cut.

7. Stop according to claim 1, further comprising a fixing means (212-301) for fixing at least one removable block (300) so that it presses against the contact face of the stop.

8. Cutting tool (100) for cutting a board made of a reconstituted material, the tool comprising a support (101-2) on which a blade (20) is mounted via a pivot (4) so that it can pivot between an open position for receiving, between the support (101-2) and the blade (20), the board that is to be cut, and a closed position at the end of cutting, the support (101-2) comprising a portion (12) equipped with a slot (3) intended to receive at least part of the blade (20) during cutting, the slot comprising a proximal end (3a) close to the pivot and a distal end (3b) distant from the pivot, characterized in that:
the slot comprises a shoulder (4) at its distal end (3b);
a stop (200) according to claim 1 is mounted removably in the slot, the central claw (202) of the stop being forcibly inserted under the shoulder (4) of the slot.

9. Cutting tool according to claim 8, further comprising at least one removable block (300) intended to be fixed so that it bears against the contact face of the stop.
